(19) United States
(12) Patent Application Publication
(10) Pub. No.: US 2025/0257717 A1
(43) Pub. Date: Aug. 14, 2025

(54) WIND TURBINE BLADE WITH A LIGHTNING RECEPTOR

(71) Applicant: LM Wind Power A/S, Kolding (DK)

(72) Inventor: Lars Bo HANSEN, Kolding (DK)

(21) Appl. No.: 18/874,125

(22) PCT Filed: Jun. 14, 2022
(86) PCT No.: PCT/EP2022/066211

§ 371 Date: Dec. 12, 2024

(51) Int. Cl. F03D 80/30

(52) U.S. Cl. CPC F03D 80/301; F05B 2280/6003

(57) ABSTRACT

The present invention provides a wind turbine blade shell part for a wind turbine blade, the blade shell part comprising: a structural element providing structural strength to the blade shell part and comprising carbon fibres embedded in a polymer matrix; a lightning receptor exposed at an outer surface of the blade shell part and extending towards the structural element; and an electrically conductive adhesive attaching the lightning receptor to the structural element. A method for manufacturing such a blade shell part is also provided.

(FIG. 8C)

### BACKGROUND OF THE INVENTION

As wind turbines and wind turbine blades increase in size, the risk of lighting striking the wind turbine increases. It is therefore of increasing interest to provide wind turbines and in particular wind turbine blades with lightning protection measures.

Lightning protection measures in a wind turbine blade typically include metallic lightning receptors exposed at the outer surface of the blades to attract lightning in case of a lightning strike. The lightning receptors are typically connected to ground through metallic conductors in order to prevent lightning current from flashing over between less conductive parts, causing heating and potentially damage the parts. Typically, blades include a downconductor cable extending substantially the entire length of the blades. The downconductor cable is typically coupled to several lightning receptors arranged along the length of the blade to reduce the risk of flashovers during a lightning strike.

As blade sizes increase, a need also arises for manufacture of blades having increased rigidity and a comparatively low increase in weight. One way of achieving these properties is to combine various kinds of fibres in the laminate of the blades. For instance, it is an option to combine glass fibres and carbon fibres or make certain components merely of carbon fibre composite. However, a high amount of carbon fibre in composite structural elements, such as spar caps, increases the risk of flashover because carbon fibres are conductive enough that lightning current will flow in the carbon spar caps during a lightning strike, which can cause substantial heating and result in structural damage to the carbon fibre composite as well as surrounding parts. It may also cause delamination between different types of composites, such as interfaces between carbon fibre composites and glass fibre composites, in part due to the difference in their mechanical, thermal, and electrical properties.

Thus, it is of increasing importance to provide lightning protection measures that reduce the risk of flashover of lightning current into electrically conductive materials such as carbon fibres composites within a wind turbine blade. Further, it is desirable that these measures are relatively easy to implement.

### SUMMARY OF THE INVENTION

It is an object of the present invention to mitigate one or more of the issues described above.

In a first aspect, the invention provides a wind turbine blade shell part for a wind turbine blade, the blade shell part comprising:
a structural element providing structural strength to the blade shell part and comprising carbon fibres embedded in a polymer matrix,
a lightning receptor exposed at an outer surface of the blade shell part and extending towards the structural element, and
an electrically conductive adhesive attaching the lightning receptor to the structural element.

The present invention reduces the risk of flashover of lightning current into electrically conductive materials such as carbon fibres composites within a wind turbine blade in case of a lightning strike to the blade.

In some embodiments, the electrically conductive adhesive adhesively attaches the lightning receptor to the structural element, as opposed to the electrically conductive adhesive holding the lightning receptor for instance by use of a threading. This can provide a strong bond between the lightning receptor and the structural element.

In some embodiments, the structural element is a spar cap. In some embodiments, the spar cap is in contact with a shear web, such as a shear web extending between the spar cap and another spar cap located in another part of the blade shell part.

In some embodiments, the structural element comprises one or more pultrusions comprising carbon fibres embedded in a polymer matrix and the electrically conductive adhesive attaches the lightning receptor to carbon fibres in one or more of the pultrusions. This provides electrical contact from the outer surface of the blade and the pultrusions, reducing the risk of flashover into the pultrusions.

In some embodiments, the structural element comprises:
one or more pultrusions comprising carbon fibres embedded in a polymer matrix, and
one or more fibre layers comprising carbon fibres, the one or more fibre layers being positioned between the outer surface of the blade shell part and one or more of the pultrusions and being adhesively attached to and in electrical contact with at least one of the one or more pultrusions,
the electrically conductive adhesive attaching the lightning receptor to carbon fibres in one or more of the fibre layers.

In such embodiments, electrical contact between the outer surface of the blade and the pultrusions is provided via the one or more fibre layers. The one or more fibre layers partly act as a sacrificial layer that introduces tolerance when then recess is being formed, as described in relation to the second aspect further below.

In some embodiments, the structural element comprises two or more pultrusions and the one or more fibre layers provide potential equalization between at least two of the pultrusions. When the one or more fibre layers extend across several pultrusions, the potential is equalized between the pultrusions, which reduces the risk of flashover between pultrusions and also reduces the resistance by ensuring that current is distributed across several pultrusions.

In some embodiments, the structural element comprises:
one or more pultrusions comprising carbon fibres embedded in a polymer matrix, and
a metallic element, such as a metallic mesh, positioned between the outer surface of the blade shell part and one or more of the pultrusions and being in electrical contact with at least one of the one or more pultrusions,
the electrically conductive adhesive attaching the lightning receptor to a part of the metallic element.

In such embodiments, electrical contact between the outer surface of the blade and the pultrusions is provided by the metallic element, such as a metal mesh, such as a copper mesh. Like the one or more fibre layers above, the metallic element may partly act as a sacrificial layer that introduces tolerance when then recess is being formed.

In some embodiments, the metallic element further extends to one or more other sides of the pultrusions. In some embodiments, the metallic element also surrounds all sides of the pultrusions. In all cases, the contact area between the pultrusions and the metallic element is increased, providing electrical coupling between more pultrusions, which provides further potential equalization between pultrusions. This further reduces the risk that the pultrusions are damaged by lightning current in case of a lightning strike.

In some embodiments, the structural element comprises two or more pultrusions and the metallic element provides potential equalization between at least two of the pultrusions. When the metallic element extends across several pultrusions, the potential is equalized between the pultrusions, which reduces the risk of flashover between pultrusions and also reduces the resistance by ensuring that current is distributed across several pultrusions.

In some embodiments, the lightning receptor abuts a lightning diverter forming part of the outer surface of the blade shell part. The connection between the lightning diverter and the lightning receptor and the connection between the lightning receptor and the structural element reduce the risk of a flashover from the lightning diverter and the structural element.

In some embodiments, the lightning receptor is located a first distance from the lightning diverter. This ensures the lightning diverter is not damaged when the lightning receptor is inserted. This is described in more detail in relation to the second aspect of the invention.

In some embodiments, the first distance is at most 20 mm, such as at most 10 mm, such as at most 5 mm. In some embodiments, the first distance is in the range 2-20 mm, such as in the range 2-15 mm, such as in the range 3-12 mm, such as in the range 3-10 mm. The distances provide a good compromise between ease of insertion of the lightning receptor and the ease with which lightning current from the lightning diverter may jump from the lightning diverter to the lightning receptor connecting the outer surface to the structural element.

In some embodiments, the lightning diverter is a segmented lightning diverter.

In some embodiments, the electrically conductive adhesive material has an electrical resistivity which is less than 1.0 10⁻⁵ Ohm-meter, such as less than 7.0 10⁻⁶ Ohm-meter, such as less than 5.0 10⁻⁶ Ohm-meter, such as less than 3.0 10⁻⁶ Ohm-meter.

In some embodiments, the electrically conductive adhesive material has an electrical resistivity which is at least 0.5 10⁻⁶ Ohm-meter, measured at 25° C.

In some embodiments, the electrically conductive adhesive material has an electrical resistivity in the range 1.0 10⁻⁶ Ohm-meter to 1.0 10⁻⁵ Ohm-meter, such as in the range 2.0 10⁻⁶ Ohm-meter to 6.0 10⁻⁶, measured at 25° C. Such values have been found to provide a good compromise between resistivity of the electrically conductive adhesive and its adhesive strength.

Adhesives such as Loctite Ablestik 57C or Loctite Ablestik 8200C provide a good balance between adhesiveness and electrical conductivity.

In some embodiments, a perimeter of the lightning receptor is surrounded by a sealant at the outer surface. This protects the structural element from water.

In some embodiments, an area of the lightning receptor at the outer surface of the blade shell part is at least 5 cm².

In some embodiments, an area of the lightning receptor at the outer surface of the blade shell part is at most 50 cm².

In some embodiments, an area of the lightning receptor at the outer surface of the blade shell part is in the range 10-30 cm².

The area of the lightning receptor at the outer surface defines a cross-sectional area of the lightning receptor. In some embodiments, the lightning receptor has a smaller cross-sectional area at the outer surface than a cross-sectional area of the first recess in which the lightning receptor is placed. This embodiment deliberately provides room for an adhesive for sealing the outer surface around the lightning receptor. In some embodiments, a ratio between the cross-sectional area of the receptor at the outer surface and the cross-sectional area of the first recess is less than 0.95, such as less than 0.9, such as less than 0.8. In some embodiments, the ratio between the cross-sectional area of the receptor at the outer surface and the cross-sectional area of the first recess is in the range 0.8-0.95.

In some embodiments, the structural element is a spar cap.

In some embodiments, the fibres in the pultrusions are substantially carbon fibres only. In some embodiments, pultrusions comprise both carbon fibres and other types of fibres, such as glass fibres and/or steel fibres.

In some embodiments, the blade shell part comprises a wind turbine blade pressure side shell half and/or a wind turbine blade suction side shell half. In some embodiments, the blade shell part is a complete wind turbine blade shell, including a pressure side and a suction side.

A second aspect of the invention provides a method for attaching a lightning receptor to a wind turbine blade shell part of a wind turbine blade to provide electrical contact between an outer surface of the blade shell part and a structural element in the blade shell part. The method comprises:
providing a blade shell part comprising a structural element, the structural element comprising carbon fibres embedded in a polymer matrix,
providing a first recess extending from an outer surface of the blade shell part towards the structural element,
applying an electrically conductive adhesive into the recess,
inserting a lightning receptor into the recess such that the electrically conductive adhesive attaches the lightning receptor to the structural element, and
curing the adhesive.

This method makes it relatively easy to provide electrical connection from an outer surface of the blade shell part and the structural element.

In some embodiments, the structural element comprises one or more pultrusions comprising carbon fibres embedded in a polymer matrix, and providing the recess exposes a part of one or more of the pultrusions without extending into any of the pultrusions.

In some embodiments, the structural element comprises:
one or more pultrusions comprising carbon fibres embedded in a polymer matrix, and
one or more fibre layers comprising carbon fibres, the one or more fibre layers being positioned between the outer surface of the blade shell part and one or more of the pultrusions and being adhesively attached to and in electrical contact with at least one of the one or more pultrusions,
the recess extending into one or more of the fibre layers, but not into any of the one or more pultrusions, the electrically conductive adhesive attaching the lightning receptor to carbon fibres in one or more of the fibre layers.

In some embodiments, the structural element comprises:
one or more pultrusions comprising carbon fibres embedded in a polymer matrix, and
a metallic element, such as a metallic mesh, positioned between the outer surface of the blade shell part and one or more of the pultrusions and being in electrical contact with at least one of the one or more pultrusions,
the recess exposing a part of the metallic element without extending into any of the one or more pultrusions, the electrically conductive adhesive attaching the lightning receptor to a part of the exposed metallic element.

In some embodiments, the lightning receptor, after insertion, abuts a lightning diverter forming part of the outer surface of the blade shell part.

In some embodiments, the blade shell part complies with the IEC 61400-24 standard (2019 version).

In some embodiments, the lightning receptor and the electrically conductive adhesive, when they are attached to the structural element, can withstand a lightning current of at least 10 kA, such as a rating in the range 10-300 kA, such as in the range 10-200 kA, such as in the range 10-100 kA. In some embodiments, the blade shell part complies with the IEC 61400-24 standard (2019 version).

In some embodiments, the lightning receptor and the electrically conductive adhesive, when attached to the structural element, can withstand a lightning strike with a charge of at least 50 Coulomb, such as a charge in the range 50-1000 Coulomb, such as in the range 50-300 Coulomb, such as in the range 100-200 Coulomb. In some embodiments, the blade shell part complies with the IEC 61400-24 standard (2019).

In some embodiments, the lightning receptor, after insertion, is located a first distance from a lightning diverter, wherein the first distance is at most 20 mm, such as in the range 2-20 mm, such as in the range 3-10 mm.

In some embodiments, a second recess is present around the lightning receptor at the outer surface after insertion of the lightning receptor into the first recess, and the method further comprises filling the second recess around the lightning receptor with a sealant.

In some embodiments, the electrically conductive adhesive material has an electrical resistivity which is less than 1.0 10⁻⁵ Ohm-meter, such as less than 7.0 10⁻⁶ Ohm-meter, such as less than 5.0 10⁻⁶ Ohm-meter, such as less than 3.0 10⁻⁶ Ohm-meter, such as less than 2.0 10⁻⁶ Ohm-meter, such as less than 1.0 10⁻⁶ Ohm-meter, measured at 25° C.

In some embodiments, the structural element is a spar cap.

In some embodiments, the fibres in the pultrusions are substantially carbon fibres only. In some embodiments, pultrusions comprise both carbon fibres and other types of fibres, such as glass fibres and/or steel fibres.

In some embodiments, the blade shell part comprises a wind turbine blade pressure side shell half and/or a wind turbine blade suction side shell half. In some embodiments, the blade shell part is a complete wind turbine blade shell, including a pressure side and a suction side.

Advantages of the various features of embodiments of the second aspect are described in relation to the first aspect. Other features from embodiments of the first aspect of the invention may be included in embodiments of the second aspect.

### BRIEF DESCRIPTION OF THE DRAWINGS

The invention is explained in detail below with reference to the embodiments shown in the drawings.

FIG. 1 illustrates a wind turbine.

FIG. 2 illustrates a wind turbine blade.

FIG. 3 illustrates a cross-section of a wind turbine blade containing structural elements.

FIG. 4 illustrates a top view of a blade shell section of a wind turbine blade comprising a structural element.

FIG. 5A illustrates a top view of a blade shell part with a lightning receptor in accordance with the invention.

FIG. 5B illustrates a detail of the top view shown in FIG. 5A.

FIG. 5C-5E illustrate a cross-section of a blade shell part in accordance with the invention.

FIGS. 6A-6D illustrate a method in accordance with the invention.

FIGS. 7A-7D illustrate a method in accordance with the invention.

FIG. 8A illustrates a top view of a blade shell part with a lightning receptor in accordance with the invention.

FIG. 8B illustrates a detail of the top view shown in FIG. 5A.

FIG. 8C illustrates a cross-section of a blade shell part in accordance with the invention.

### DETAIL DESCRIPTION OF SELECTED EMBODIMENTS

Embodiments of the invention will be described in more detail in the following with reference to the accompanying drawings. Like reference numerals may refer to like elements throughout. The drawings show selected ways of implementing the present invention and are not to be construed as limiting the scope of the claims. The drawings are not necessarily drawn to scale.

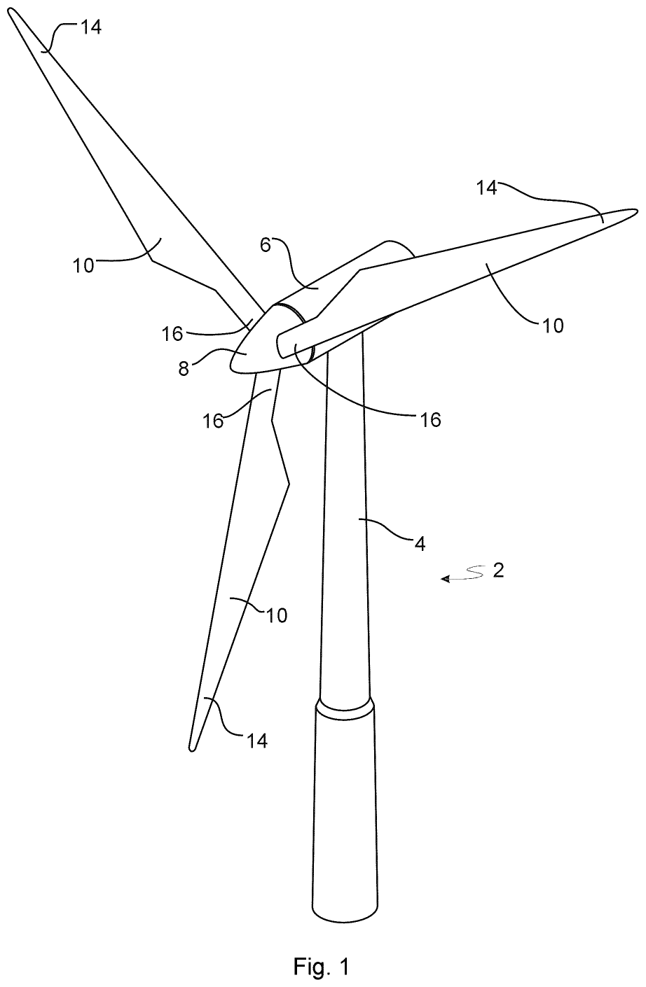

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8.

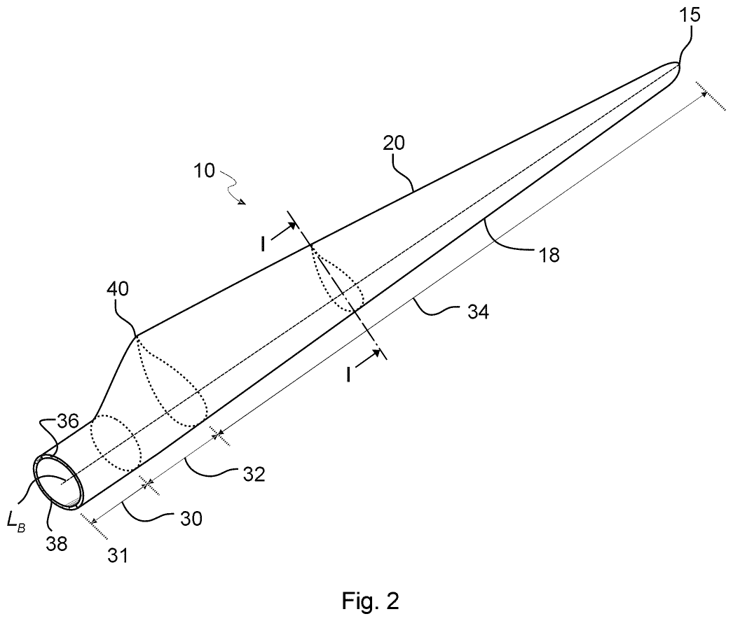

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18. The outermost point of the blade 10 is the tip end 15, located opposite the root end 31 that attaches to the wind turbine hub 8.

The airfoil region 34, also called the profiled region, of the wind turbine blade has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant or may vary along the root region 30. The transition region 32 has a transitional profile gradually changing from the circular or elliptical shape of the root region 30 to the airfoil profile of the airfoil region 34. The chord length of the transition region 32 typically increases with increasing distance from the hub. The airfoil region 34 has an airfoil profile with a chord that extends between the leading edge 18 and the trailing edge 20 of the blade 10. The chord usually decreases with increasing distance from the hub.

A shoulder 40 of the blade 10 is defined as the position where the blade 10 has its largest chord length. The shoulder 40 is typically located at the boundary between the transition region 32 and the airfoil region 34. FIG. 2 also illustrates the longitudinal extent L_{B} of the blade 10. L_{B} also represents a longitudinal axis of the blade 10.

The blade is typically made from a pressure side shell part 36 and a suction side shell part 38 that are glued to each other along bond lines at the leading edge 18 and the trailing edge 20 of the blade 10.

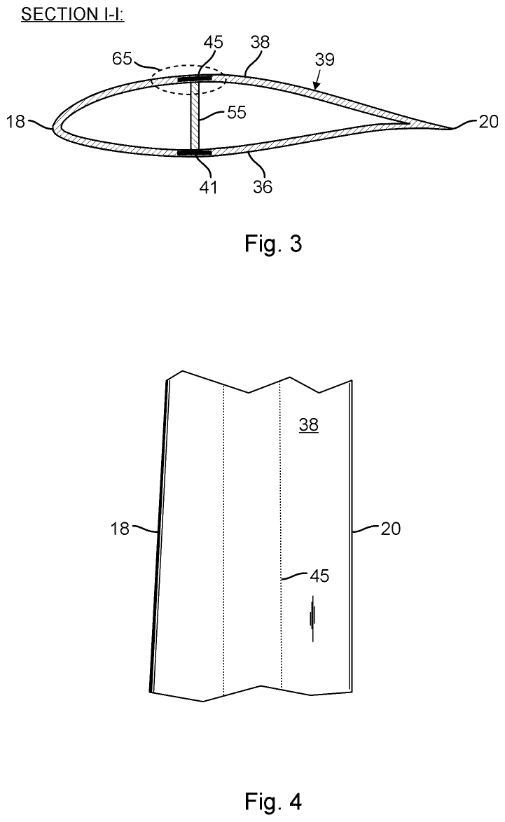

FIG. 3 schematically illustrates the cross-section I-I (see FIG. 2) of the wind turbine blade 10. The cross-section I-I illustrates the suction side shell part 38, the pressure side shell part 36, the leading edge 18 and the trailing edge 20 of the wind turbine blade 10 shown in FIG. 2. Further, the wind turbine blade 10 comprises a structural element 45, such as a spar cap, in the suction side part 38 of the shell and a spar cap 41 in the pressure side part 36 of the blade 10. A shear web 55 extends between the two spar caps 41, 45 and provides resistance to shear forces. The portion 65 indicated in FIG. 3 is described in further detail below in relation to different embodiments of the invention. FIG. 3 also indicates an outer surface 39 of the suction side part 38.

Carbon fibre composites are used in wind turbine blades in part because they are lighter and stiffer by volume than glass fibre composites. Structural elements, such as spar caps, often comprise carbon fibre composite material, which improves the overall mechanical properties of blades. However, carbon fibre composites can conduct current during a lightning strike, although poorly, and thus carbon fibre composites are more susceptible to flashover than for instance glass fibre composites. Flashovers cause heating that can damage the carbon fibre composite and other parts, such as glass fibre composite material, in the vicinity.

FIG. 4 schematically illustrates a portion of the suction side blade shell 38 of a wind turbine blade. FIG. 4 is a view towards the outer surface 39 (see FIG. 3) of the suction side blade shell 38. The structural element 45, such as a spar cap, is located below the outer surface 39 of the suction side shell part 38. In some embodiments, the structural element 45 is separated from the outer surface 39 by a gelcoat and in some embodiments by composite material and/or one or more metallic elements. The present invention provides electrical contact between the outer surface 39 and the structural element 45, thereby reducing the risk that a lightning strike causes a flashover to the structural element 45 and damages the wind turbine blade.

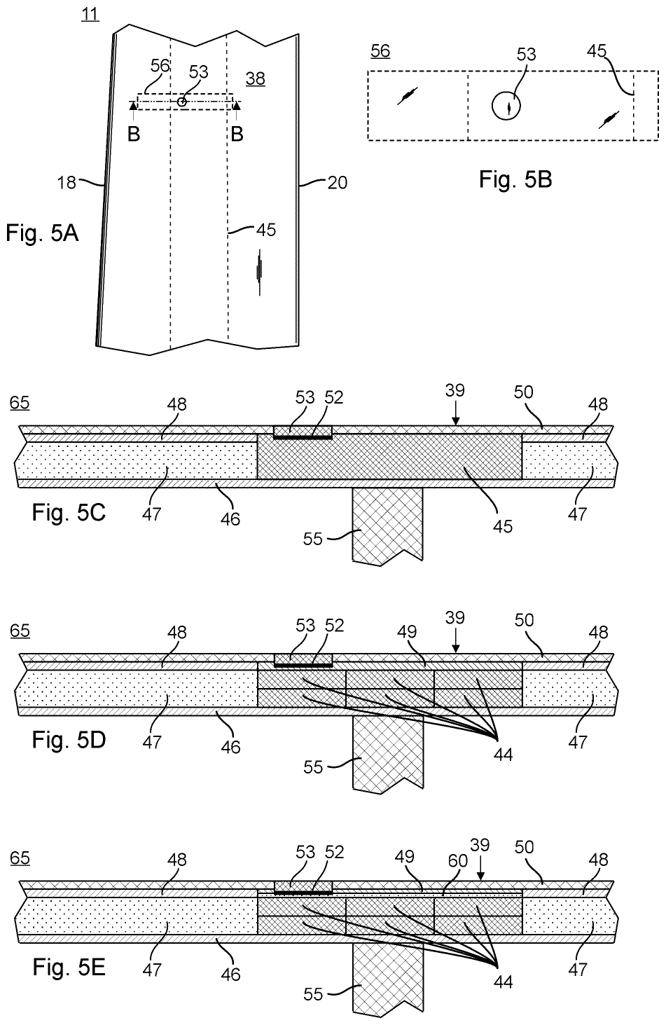

FIG. 5A illustrates a portion of a blade shell part 11 in accordance with the invention, in this example a portion of a suction side blade shell 38. A lightning receptor 53 is exposed at the outer surface of the blade. In the present example, the lightning receptor 53 is located over the spar cap 45, which is situated under the outer surface 39 (see FIG. 3) of the suction side blade shell 38. The lightning receptor 53 attracts lightning in case of a lightning strike, thereby reducing the risk that lightning causes a flashover at least in the vicinity of the lightning receptor 53. The region 56 indicated in FIG. 5A is shown enlarged in FIG. 5B, showing the lightning receptor 53 arranged over the spar cap 45 located in the suction side blade shell 38.

FIG. 5C illustrates the portion 65 (defined in FIG. 3) of a cross-section of the blade shell part 11 shown in FIG. 5A. The portion 65 includes the structural element 45, part of the shear web 55, an outermost gelcoat layer 50, outer glass fibre composite layers 48, core material 47, such as foam, and inner glass fibre composite layers 46. As seen from FIG. 5C, the lightning receptor 53 extends from the outer surface 39 towards the structural element 45 and is in contact with the structural element 45. In accordance with the invention, the lightning receptor 53 is adhesively attached to the structural element 45 using an electrically conductive adhesive 52, as shown in FIG. 5C.

A method of manufacturing such a blade shell part 11 is described in more detail further below. The different structures shown in the figures shall not be construed as limiting the scope of the claims.

FIG. 5D illustrates another embodiment of the invention. In this example, the structural element 45 comprises (six) pultrusions 44 providing strength and stiffness to the blade. The embodiment also includes a material portion 49 positioned between the pultrusions 44 and the outer surface 39, in this example a gelcoat layer 50. The additional material 49 in part acts as a buffer in the sense that it is easier to provide electrical contact to the pultrusions without damaging the pultrusions 44. The buffer may be provided as adhesively attached to the pultrusions before layup of the blade shell part 11, or it may be laid up separately in the blade shell part mould before the pultrusions 44 are added to the layup. Subsequent resin infusion will then bond the buffer 49 to the one or more pultrusions 44. The buffer may for instance comprise one or more fibre layers, such as fibre layers comprising carbon fibre, such as fibre layers in which the fibres are exclusively made of carbon.

FIG. 5E illustrates another embodiment of the invention. In this example, the buffer 49 positioned between the outer surface 39 and the pultrusions 44 comprises one or more carbon fibre layers 49 and a metallic element 60, made for instance from copper, or aluminium brass or tungsten or titanium or stainless steel or gold, or an alloy of one or more of these. In some embodiments, the metallic element is a mesh. Like the one or more fibre layers 49 in the embodiment in FIG. 5D, the copper mesh is in electrical connection with the carbon pultrusions 44 and thereby equalize the potential across the pultrusions. This allows lightning current to be distributed across the different pultrusions, reducing the resistance and in turn reducing heating caused by a lightning strike. The metallic element 60 may be provided adhesively attached to one or more of the pultrusions 44 before layup of the blade shell part (optionally together with the fibre layers 49 or other material positioned between the metallic mesh 60 and the pultrusions 44), or it may be laid up separately before pultrusions 44 are added to the blade shell part layup.

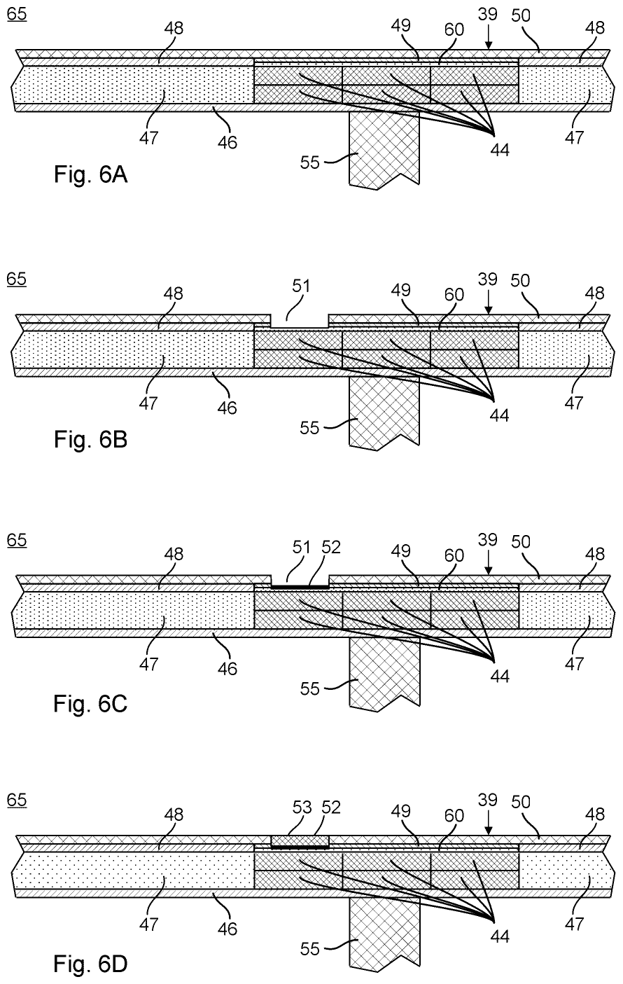

FIGS. 6A-6D illustrate a method in accordance with the invention. The steps provide electrical contact between an outer surface of the blade shell part 11 and the structural element 45 in the blade shell part 11.

FIG. 6A is similar to FIG. 5E above but shows the blade shell part before the lightning receptor is added.

After providing the blade shell part 11 comprising pultrusions 44 and the buffer, which in this example comprises carbon fibre layers 49 and a copper mesh 60, a first recess 51 is formed into the blade shell part 11 as shown in FIG. 6B. In the example, the first recess 51 extends from the outer surface 39 blade shell part through the one or more fibre layers 49, and finally exposes a part of the metallic element 60. The first recess 51 does not extend into any of the one or more pultrusions since this will weaken the strength of the pultrusion. The buffer makes it easier to form the recess 51 while not damaging the pultrusions 44. In a sense, it partly acts as a sacrificial layer and provides some tolerance when then recess 51 is being formed.

FIG. 6C illustrates a step of applying an electrically conductive adhesive 52 in the first recess 51 in such a way that the electrically conductive adhesive 52 can subsequently adhesively attach the exposed part of the metallic element 60 to the lightning receptor 53 when the lightning receptor 53 is inserted. The electrically conductive adhesive 52 may for instance have an electrical resistivity of at most 1.0 10⁻⁵ Ohm-meter, measured at 25° C. This ensures a sufficiently high conductivity between the lightning receptor 53 and the metallic element 60. Loctite provides adhesive materials that have an electrical resistivity below 1.0 10⁻⁵ Ohm-meter.

Next, as illustrated in FIG. 6D, the lightning receptor 53 is inserted into the first recess 51 such that it becomes adhesively attached to the metallic element 60 via the electrically conductive adhesive 52, thereby being in electrical connection with the copper mesh 60 with low resistance.

Preferably, the electrically conductive adhesive effectively seals off the layers below the gelcoat 50 from any water outside the blade shell part 11. If needed, a sealant may be applied to completely seal the outer surface 39 from any water outside the blade shell part 11.

Finally, the adhesive 52 and any sealant are cured. This results in the blade shell part shown in FIG. 5E.

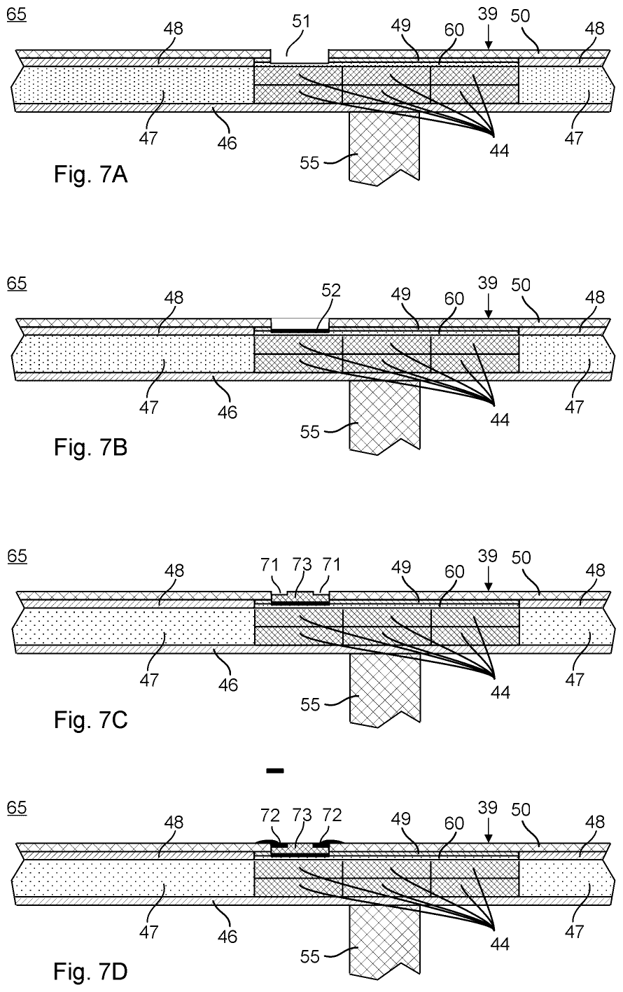

FIGS. 7A-7D illustrate another method in accordance with the invention. The method is similar to the method described above in relation to FIGS. 6A-6D. However, the method described below provides an improved seal around the lightning receptor.

FIG. 7A corresponds to FIG. 6B, showing the blade shell part with the first recess 51 having been formed to expose the metallic element 60. FIG. 7B corresponds to FIG. 6C, illustrating application of the electrically conductive adhesive 52 in the first recess 51.

The method differs from the method described above in that a different lightning receptor 73 is used. The lightning receptor 73 is formed such that, when inserted in the first recess 51, a significant second recess 71 is present around the lightning receptor 73 at the outer surface of the blade shell part 11. This is illustrated in FIG. 7C. The lightning receptor 73 has a smaller cross-sectional area at the outer surface than the cross-sectional area of the first recess 51. For instance, a ratio between the cross-sectional area of the receptor 73 at the outer surface and the cross-sectional area of the first recess 51 may be less than 0.95, such as less than 0.9, such as less than 0.8.

FIG. 7D illustrates sealing the second recess 71 by filling the second recess 71 around the lightning receptor 73 with a sealant 72. This more effectively seals the outer surface from any water outside the blade shell part compared to the lightning receptor 53 shown in FIG. 6D, which fits snugly but for that reason is more difficult to seal. In the example, the sealant 72 extends onto the outer surface 39 where it is preferably rounded and thin so as to not impact the aerodynamic properties of the blade. By extending the sealant 72 onto the outer surface 39, the seal becomes very strong. If moist gets to the electrically conductive adhesive, such as a silver Loctite, an oxidation process will start that will adversely affect the electrically conductive adhesive, both its mechanical properties and its electrical properties.

Alternatively, the sealant 72 may be flush with the outer surface 39, but this may result in a less efficient seal having a shorter service life. If the seal breaks, oxidation of the electrically conductive adhesive will occur, as described above, and the mechanical and electrical properties of the electrically conductive adhesive will deteriorate.

Finally, the adhesive and the sealant are cured.

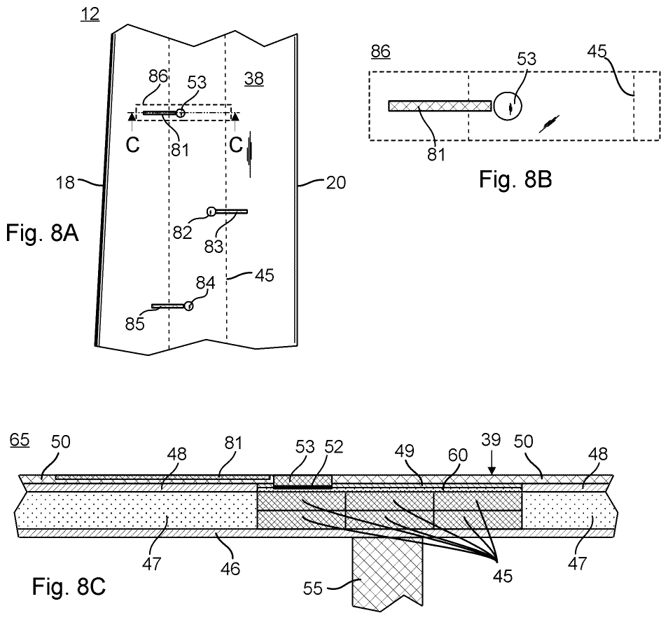

FIGS. 8A-8C illustrate another embodiment of the invention. It is similar to the embodiment shown in FIG. 5E. However, as shown in FIG. 8A, the outer surface 39 includes a lightning diverter 81, such as a segmented lightning diverter. In the present example, the segment lightning diverter is located close to, but not abutting the lightning receptor 53. The region 86 indicated in FIG. 8A is shown in more detail in FIG. 8B, which also illustrates a distance between the lightning diverter 81 and the receptor 53. The segmented diverter may for instance be provided when manufacturing the blade shell part, or it may be added after embedding fibre layers, pultrusions, and one or more metallic elements in resin.

The blade shell part may include a plurality of lightning receptors 53, 82, and 84, as shown in FIG. 8A. In the embodiment in FIG. 8A, there are corresponding lightning diverters 81, 83, and 85 in combination with respective lightning receptors 53, 82, and 84.

An advantage of placing the lightning receptor 53 a distance from the lightning diverter 81 is that the lightning diverter 81 is not damaged when providing the recess 51, which could happen if the recess 51 is provided abutting the lightning diverter 81 or even formed overlapping part of the lightning diverter 81.

### LIST OF REFERENCES

2 wind turbine
4 tower
6 nacelle
8 hub
10 blade
11,12 blade shell part
14 blade tip
15 tip end
16 blade root
18 leading edge
20 trailing edge
30 root region
31 root end
32 transition region
34 airfoil region
36 pressure side shell part
38 suction side shell part
39 outer surface of blade shell part
40 shoulder
41,45 structural element/load-carrying structure/spar cap
44 pultrusions comprising carbon fibre material
46 fibre composite layers
47 core material
48 fibre composite layers
49 additional material, buffer
50 gelcoat
51 recess
52 electrically conductive adhesive
53 lightning receptor
55 shear web
56 region of blade shell part
60 metallic element, copper mesh
65 portion of blade shell part
71 recess surrounding lightning receptor
72 adhesive surrounding lightning receptor at outer surface
73 lightning receptor
81, 83, 85 lightning diverter, segmented lightning diverter
82, 84 lightning receptor
86 region of blade shell part
L_{B} length/longitudinal axis of blade

1-27. (canceled)

28. A blade shell part for a wind turbine blade, the blade shell part comprising:
a structural element providing structural strength to the blade shell part and comprising one or more pultrusions comprising carbon fibers embedded in a polymer matrix;
a lightning receptor exposed at an outer surface of the blade shell part and extending towards the structural element; and
an electrically conductive adhesive attaching the lightning receptor to the carbon fibers in the one or more pultrusions of the structural element.

29. The blade shell part of claim 28, further comprising one or more fiber layers comprising carbon fibers, the one or more fiber layers being positioned between the outer surface of the blade shell part and one or more of the pultrusions and being adhesively attached to and in electrical contact with at least one of the one or more pultrusions, the electrically conductive adhesive attaching the lightning receptor to the carbon fibers in one or more of the fiber layers.

30. The blade shell part of claim 28, wherein the structural element further comprises a metallic element positioned between the outer surface of the blade shell part and the one or more pultrusions and being in electrical contact with at least one of the one or more pultrusions, the electrically conductive adhesive attaching the lightning receptor to a part of the metallic element.

31. The blade shell part of claim 30, wherein the one or more fiber layers or the metallic element provides potential equalization between at least two of the one or more pultrusions.

32. The blade shell part of claim 28, wherein the lightning receptor abuts a lightning diverter forming part of the outer surface of the blade shell part, and wherein the lightning receptor is located a first distance from the lightning diverter forming part of the outer surface of the blade shell part.

33. The blade shell part of claim 32, wherein the lightning diverter is a segmented lightning diverter.

34. The blade shell part of claim 32, wherein the first distance is in the range of 2 millimeters (mm) to 20 mm.

35. The blade shell part of claim 28, wherein the electrically conductive adhesive material has an electrical resistivity in the range 1.0 10⁻⁶ Ohm-meter to 1.0 10⁻⁵ Ohm-meter measured at 25° C.

36. The blade shell part of claim 28, wherein a perimeter of the lightning receptor is surrounded by a sealant at the outer surface.

37. The blade shell part of claim 28, wherein the structural element is a spar cap.

38. The blade shell part of claim 28, wherein the blade shell part comprises at least one of a pressure side shell or a suction side shell. 39 The blade shell part of claim 28, wherein the lightning receptor and the electrically conductive adhesive, when attached to the structural element, can withstand a lightning current of at least 10 kA.

40. The blade shell part of claim 28, wherein the lightning receptor and the electrically conductive adhesive, when attached to the structural element, can withstand a lightning charge during a lightning strike of at least 50 Coulomb.

41. A method for attaching a lightning receptor to a wind turbine blade shell part of a wind turbine blade to provide electrical contact between an outer surface of the blade shell part and a structural element in the blade shell part, the method comprising:
providing a blade shell part comprising a structural element, the structural element comprising one or more pultrusions comprising carbon fibers embedded in a polymer matrix;
providing a first recess extending from an outer surface of the blade shell part towards the structural element, the recess exposing a part of one or more of the pultrusions without extending into any of the pultrusions;
applying an electrically conductive adhesive into the recess;
inserting a lightning receptor into the recess such that the electrically conductive adhesive attaches the lightning receptor to the carbon fibers in the one or more pultrusions of the structural element; and
curing the electrically conductive adhesive.

42. The method of claim 41, further comprising one or more fiber layers comprising carbon fibers, the one or more fiber layers being positioned between the outer surface of the blade shell part and one or more of the pultrusions and being adhesively attached to and in electrical contact with at least one of the one or more pultrusions, the electrically conductive adhesive attaching the lightning receptor to the carbon fibers in one or more of the fiber layers.

43. The method of claim 41, wherein the structural element further comprises a metallic element positioned between the outer surface of the blade shell part and the one or more pultrusions and being in electrical contact with at least one of the one or more pultrusions, the electrically conductive adhesive attaching the lightning receptor to a part of the metallic element.

44. The method of claim 41, wherein the lightning receptor, after insertion, abuts a lightning diverter forming part of the outer surface of the blade shell part.

45. The method of claim 41, wherein the lightning receptor, after insertion, is located a first distance from a lightning diverter.

46. The method of claim 41, wherein a second recess is present around the lightning receptor at the outer surface after insertion of the lightning receptor into the first recess, and wherein the method further comprises filling the second recess around the lightning receptor with a sealant.

47. The method of claim 41, wherein the electrically conductive adhesive material has an electrical resistivity which is less than 1.0 10⁻⁵ Ohm-meter measured at 25° C.
